(19) United States
(12) Patent Application Publication
(10) Pub. No.: US 2017/0061057 A1
(43) Pub. Date: Mar. 2, 2017

(54) INTEGRATED CIRCUIT DESIGN METHOD REDUCING CLOCK POWER AND INTEGRATED CLOCK GATER MERGED WITH FLIP-FLOPS

(71) Applicant: SAMSUNG ELECTRONICS CO., LTD., Suwon-Si (KR)

(72) Inventor: TAE HEE LEE, SUWON-SI, GYEONGGI-DO (KR)

(21) Appl. No.: 15/249,611

(22) Filed: Aug. 29, 2016

(30) Foreign Application Priority Data
Aug. 28, 2015 (KR) 10-2015-0121900

(51) Int. Cl. G06F 17/50

(52) U.S. Cl. CPC G06F 17/5072

(57) ABSTRACT

A method of generating a design for an integrated circuit includes replacing a first clock network with a second clock network in the design, wherein the second clock network is defined by a standard cell stored in a storage device. The first clock network includes a first clock gater connected to first clock sinks via intervening inverters, and the second clock network includes a second clock gater directly connected to second clock sinks without intervening inverters.

### CROSS-REFERENCE TO RELATED APPLICATION

This application claims priority under 35 U.S.C. §119(a) from Korean Patent Application No. 10-2015-0121900 filed on Aug. 28, 2015, the disclosure of which is hereby incorporated by reference in its entirety.

### BACKGROUND

Embodiments of the inventive concept relate to design method(s) yielding integrated circuit(s) exhibiting reduced power consumption associated with operation of a clock network (hereafter, “clock power”). Embodiments of the inventive concept further relate to integrated circuits including an integrated clock gating cell (hereafter, “integrated clock gater” or “ICG”) and multiple clock sinks (e.g., flip-flops) having reduced clock power, as well as design methods that generate single standard cell designs enabling the fabrication of same.

Various clock signals are vital control mechanisms in most contemporary semiconductor devices. As the complexity of semiconductor devices has increased, so too has the complexity of clock signal applications, timing considerations, and associated physical layout issues. A clock network is understood to include multiple clock sinks, such as flips flops, and an ICG. A number of clock gating techniques are conventionally used to control the operational timing (e.g., synchronization) of the various clock sinks and related components. For example, clock gating considerations often seek to reduce the amount of power consumed by operation of a clock network. In this context, a clock gater is a circuit or component that controls the application or non-application (or enable/disable) of one or more clock signal(s) in relation to one or more clock sink(s).

As shown in FIG. 1A, an exemplary clock network 100A, as might be found in an integrate circuit, includes a clock gater 110A connected to a plurality of flip-flops (FF) through a number of inverters (e.g., INT1, INT2, and INT3). The clock gater 110A is assumed to receive as inputs a clock signal (CLK) and an enable signal (EN). The inverters INT1, INT2 and INT3 are used to control clock slew and/or selectively delay a selectively enabled clock signal provided as an output by the clock gater 110A. Thus, the second and third inverters (INT2 and INT3) receive as an input signal, an enabled and selectively delayed clock signal provided by the first inverter INT1 in the illustrated example of FIG. 1A. Unfortunately, each of the inverters (e.g., INT1, INT2 and INT3) in a clock network consumes some portion of clock power. The conventionally necessary inclusion of multiple inverters also tends to drive up the physical size or layout space required by the constituent clock network. Still further, the inclusion of multiple inverters increases overall clock signal (CLK) latency.

### SUMMARY

Certain embodiments of the inventive concept effectively merge a clock gater with multiple clock sinks (e.g., flip-flops) into a single standard cell that may be used in a cell library of the type used to fabricate semiconductor devices. Embodiments of the inventive concept provide design methods enabling the merging of a clock gater with multiple clock sinks to reduce clock power, as well as the total number of inverters included in a clock network. Embodiments of the inventive concept provide design methods that better optimize clock power for clock networks including a clock gater and multiple clock sinks.

An example embodiment of the inventive concept is directed to a method for designing an integrated circuit, including determining whether or not to replace first clock sinks, a plurality of inverters, and a first clock gater with one standard cell, and placing the standard cell instead of the first clock sinks, the plurality of inverters, and the first clock gater based on a result of the determination, in which the standard cell includes a second clock gater and second clock sinks, and an output terminal of the second clock gater is directly connected to a clock terminal of each of the second clock sinks.

An example embodiment of the inventive concept is directed to a method of designing an integrated circuit. The method includes referencing a netlist related to the integrated circuit design, a cell library related to the netlist, and constraints related to the netlist. The method also includes generating a first clock network connecting a first clock gater to first clock sinks via intervening inverter, wherein the netlist, cell library and constraints are stored in at least one storage device. The method also includes; determining whether the first clock network satisfies the constraints after changing a placement position of at least one of the first clock sinks, and generating a standard cell that defines a second clock network replacing the first clock network, wherein the second clock network includes a second clock gater directly connected to second clock sinks without intervening inverters.

An example embodiment of the inventive concept is directed to a method of designing a standard cell defining a clock network including a clock gater and clock sinks. The method includes; identifying an overlapping timing slack region between the clock gater and clock sinks, placing the clock gater and clock sinks in the overlapping timing slack region, and after placement of the clock gater and clock sinks in the overlapping region determining whether the standard cell satisfies at least one of a density constraint and a clock skew constraint, wherein the clock gater is directly connected to the clock sinks without intervening inverters.

According to exemplary embodiments, a density of the bin is determined based on a placement area of the first clock sinks, a placement area of combinational logic cells placed in the bin, a width of the bin, and a height of the bin.

According to exemplary embodiments, a density of the bin DOB is determined by

$$D O B = \frac{{A}_{F} + {A}_{C}}{W H} ,$$

A_{F} res a placement area of the first clock sinks, A_{C} res a placement area of combinational logic cells placed in the bin, W represents a width of the bin, and H represents a height of the bin.

According to exemplary embodiments, when a density of the bin is equal to or less than the maximum placement density, the placing places the standard cell in the overlapped region. According to exemplary embodiments, when a density of the bin is equal to or less than the maximum placement density, the determining further includes determining whether or not a clock skew constraint is satisfied.

According to exemplary embodiments, the determining whether or not the clock skew constraint is satisfied includes calculating a first distance between one of the first clock sinks and a clock root, calculating a second distance between the other of the first clock sinks and the clock root, calculating a difference between the first distance and the second distance, and determining whether or not the distance is equal to or less than a maximum skew allowable distance.

According to exemplary embodiments, when the distance is equal to or less than the maximum skew allowable distance, the placing places the standard cell in the overlapped region.

The one is a clock sink placed closest to the clock root among the first clock sinks, and the other is a clock sink placed farthest from the clock root among the first clock sinks.

Each of the second clock sinks includes a master latch and a slave latch, and the output terminal of the second clock gater is directly connected to a clock terminal of the slave latch included in each of the second clock sinks.

The second clock gater includes a mask circuit which masks a clock signal in response to an enable signal, and an inverter which is connected between an output terminal of the mask circuit and the output terminal of the second clock gater, and the output terminal of the mask circuit is directly connected to a clock terminal of the master latch included in each of the second clock sinks. The method for designing an integrated circuit further includes placing the standard cell in a clock path. An integrated circuit according to an exemplary embodiment of the inventive concept is manufactured according to the method for designing an integrated circuit.

An example embodiment of the inventive concept is directed to a method for designing an integrated circuit, including receiving a netlist related to the integrated circuit design, receiving a cell library related to the netlist and constraints related to the netlist, placing first clock sinks, a plurality of inverters, and a first clock gater using the netlist and the cell library, determining whether or not the first clock sinks satisfy the constraints by changing a placement position of the first clock sinks, and placing a standard cell instead of the first clock sinks, the plurality of inverters, and the first clock gater based on a result of the determination, in which the standard cell includes a second clock gater and second clock sinks, and an output terminal of the second clock gater is directly connected to a clock terminal of each of the second clock sinks.

When the constraints include a timing constraint, the determining includes checking a timing slack free region of each of the first clock sinks, checking a timing slack free region of the first clock gater, and determining whether or not an overlapped region between the timing slack free region of each of the first clock sinks and the timing slack free region of the first clock gater is.

When the overlapped region is and the constraints further include a density constraint, the determining further includes determining whether a density of a bin related to the overlapped region is equal to or less than a maximum placement density.

When the overlapped region is, a density of the bin is equal to or less than the maximum placement density, and the constraints further include a clock skew constraint, the determining further includes calculating a first distance between one of the first clock sinks and a clock root, calculating a second distance between the other of the first clock sinks and the clock root, calculating a difference between the first distance and the second distance, and determining whether the difference is equal to or less than a maximum skew allowable distance. The placing places the standard cell in the overlapped region when the difference is equal to or less than the maximum skew allowable distance.

### BRIEF DESCRIPTION OF THE DRAWINGS

These and/or other aspects and advantages of the inventive concept will become more apparent and better appreciated upon review of the following description of embodiments taken in conjunction with the accompanying drawings of which:

FIG. 1A is a block diagram of a conventional clock network;

FIG. 1B is a block diagram of a clock network defined by a standard cell according to exemplary embodiments of the inventive concept and includes a clock gater and clock sinks;

FIG. 2 is a block diagram of a clock network defined by a standard cell according to exemplary embodiments of the inventive concept and includes a clock gater and clock sinks;

FIG. 3 is a flowchart which describes a method for designing an integrated circuit that includes a standard cell according to exemplary embodiments of the inventive concept;

FIG. 4 shows a timing slack free region overlapped with timing slack free regions;

FIG. 5 is a conceptual diagram which describes a timing constraint for generating the standard cell according to exemplary embodiments of the inventive concept;

FIG. 6 is a conceptual diagram which describes a density constraint of a bin for generating the standard cell according to exemplary embodiments of the inventive concept;

FIG. 7 is a conceptual diagram which describes a clock skew constraint for generating the standard cell according to exemplary embodiments of the inventive concept;

FIG. 8 shows a standard cell placed in an overlapped timing slack free region according to exemplary embodiments of the inventive concept;

FIG. 9 is a flowchart which describes a method for designing an integrated circuit that includes the standard cell according to exemplary embodiments of the inventive concept;

FIG. 10 shows an exemplary embodiment of a clock path which includes the standard cell according to exemplary embodiments of the inventive concept;

FIG. 11 shows an exemplary embodiment of the clock path which includes the standard cell according to exemplary embodiments of the inventive concept;

FIG. 12 shows a block diagram of a computing system for designing an integrated circuit which includes the standard cell according to exemplary embodiments of the inventive concept; and

FIG. 13 is a flowchart which describes a method for designing an integrated circuit which includes the standard cell according to exemplary embodiments of the inventive concept using the computing system shown in FIG. 12.

### DETAILED DESCRIPTION

Certain embodiments of the inventive concept will now be described in some additional detail with reference to the drawings. It should be noted, however, that these embodiments are presented as examples. The scope of the inventive concept is not limited to only the illustrated embodiments set forth herein. Rather, these embodiments are provided so that this disclosure will be thorough and complete, and will fully convey the scope of the inventive concept to those skilled in the art. Throughout the written description and drawings, like reference numbers and labels are used to denote like of similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

The design and fabrication of contemporary semiconductor devices and related integrated circuits is extremely complex. To facilitate the practical design of these devices and circuits, a collection or library of design “cells” is used. Each cell in the library essentially defines a corresponding integrated circuit, component, element, or portion thereof. Cells may be “standard” or “custom” in their nature. And while this designation is often one of interpretation and use, a standard cell is one which may be repeated incorporated into many different semiconductor devices and related integrated circuits.

Accordingly, during the design of a semiconductor device, a standard cell methodology may be understood as an approach wherein an application specific integrated circuit (ASIC), for example, is designed using, at least in part, certain standard digital and/or logic features. Thus, a standard cell may include a group of transistors, as well as corresponding interconnect structures, such as layout wiring. These collections of transistors, related elements and interconnect structures may be used to provide a Boolean logic function (e.g., an AND gate, OR gate, XOR gate, XNOR gate, inverter, etc.) or a digital data bit(s) storage function (e.g., a flip-flop, register, latch, etc.). However, these are just ready examples of digital/logic features that may be efficiently implemented using one or more standard cells of a given library.

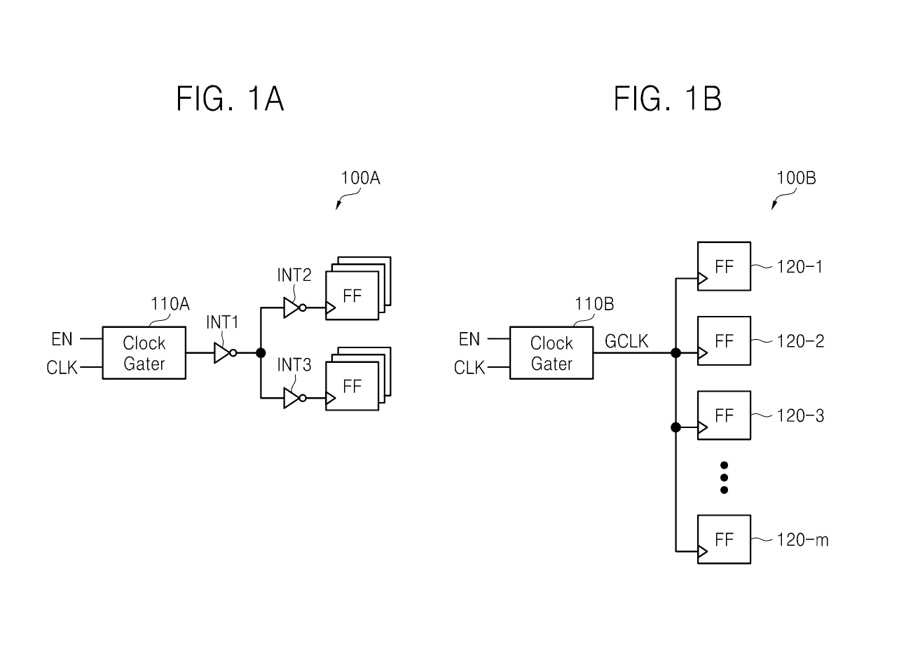

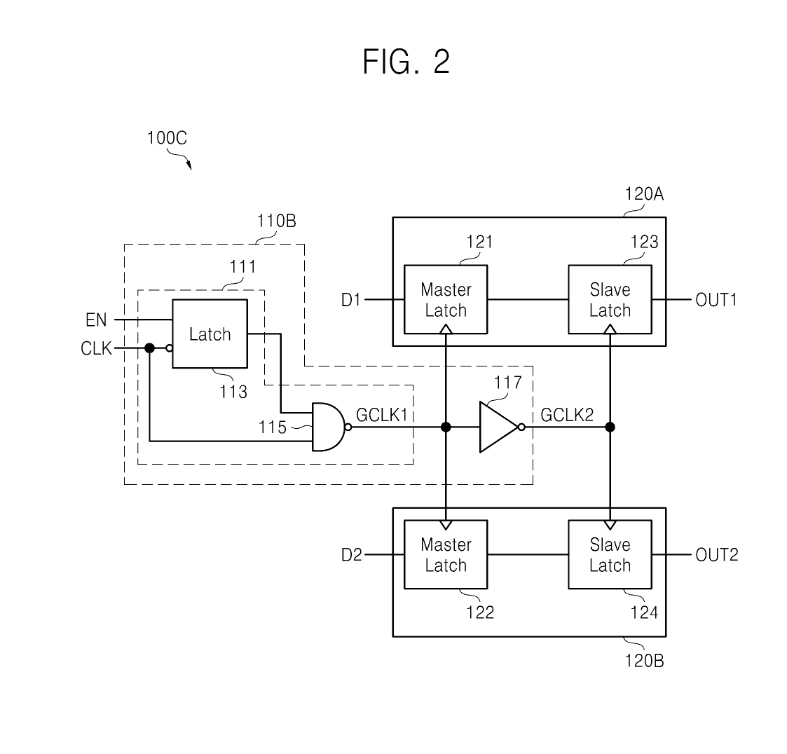

Two standard cells 100B and 100C are respectively illustrated in FIGS. 1B and 2. Those skilled in the art will recognize that these are merely examples of numerous standard cells that currently exist or may exist in the future. The illustrated standard cells 100B or 100C are, however, standard cells defining respective clock networks because they include a clock gater merged with multiple clock sinks. Accordingly, those skilled in the art will further recognize that each one of the standard cells 100B or 100C may be considered a “merged standard cell”, since various clock gaters may be defined by a corresponding standard cell, and respective, one or more, clock sinks may be defined by corresponding standard cell(s). Hereafter, it is assumed that various merged standard cells are considered to be standard cells for the sake of simplicity. Here, a clock gater may be a clock gating logic circuit or an integrated clock gating (ICG) cell, for example. A clock sink may be an electronic element operating in response to a clock signal. Thus, ready examples of clock sinks include; flip-flop(s), register(s), latch(es), sequential logic circuit(s), and/or sequential logic cell(s). As a result, in the context of the present description, a standard cell library may include a collection of relatively low-level electronic logic functions (e.g., AND, OR, XOR, XNOR gate(s), one or more inverter(s), latch(es), and/or buffer(s)). Further, some of the standard cells may be merged standard cells derived from more basic standard cells. Each standard cell is associated with one or more “constraints”, such as for example, a timing constraint, a size constraint, a power consumption constraint, and a connectivity constraint.

FIG. 1B is a block diagram of a clock network 100B as defined by a standard cell consistent with an embodiment of the inventive concept. The clock network 100B includes a clock gater 110B and multiple clock sinks (e.g., flop-flops 120-1 through 120-m, where ‘m’ is a natural number greater than 3). According to certain embodiments of the inventive concept, a standard cell defining a clock network does not include multiple (i.e., more than one) inverters disposed between an output of the clock gater 110B and respective clock signal inputs of the multiple clock sinks. Referring to FIG. 1, inverter INT1, INT2 and INT3 may be considered “intervening inverters” because they are respectively disposed between an output of the clock gater 110A and input(s) of one or more clock sinks. Thus, certain embodiments of the inventive concept may be said to omit or lack intervening inverters. Alternately expressed, in a clock network according to certain embodiments of the inventive concept, a clock gater may be said to be “directly connected to” multiple clock sinks “without intervening inverters”. Indeed, the omission of intervening inverters in certain embodiments of the inventive concept may be deemed a standard cell design constraint.

In FIG. 1B, the clock gater 110B controls the enabling/disabling of a clock signal CLK in response to an enable signal EN applied to the clock gater 110B. The resulting clock signal provided at an output of the clock gater 110B will be referred to as a “gated clock signal” or GCLK. Each clock terminal of the clock sinks 120-1 to 120-m directly receives—without intervening inverter(s)—the gated clock signal GCLK. And since intervening inverters have been omitted from the design of the clock network 100B, the clock network 100B will operate with reduced clock power and clock latency conventionally associated with the intervening inverters. Moreover, a layout area (or size) of the clock network 100B may be reduced when compared to an equivalent clock network like the one illustrated in FIG. 1A. Since the intervening inverters are omitted from the standard cell defining the clock network 100B, overall wire length between the clock gater 110B and each clock sinks 120-1 to 120-m may be reduced.

FIG. 2 is a block diagram of another clock network 100C that may be defined by a standard cell consistent with an embodiment of the inventive concept. Here, the clock network 100C includes clock gater 110B and first and second clock sinks (e.g., master/slave latch configurations or “registers” 120A and 120B). Of course, only two (2) clock sinks are illustrated in FIG. 2, but those skilled in the art will recognize that more than two clock sinks may be directly connected to the clock gater 110B without intervening inverters.

The clock gater 110B generates a first gated clock signal GCLK1 provided at a first output ‘A’ of the clock gater 110B, and a second gated clock signal GCLK2 (e.g., an inverted version of the first gated clock signal GCLK1) provided at a second output ‘B’ of the clock gater 110B in response to the enable signal EN. Here, an inverter 117 used to generate the second gated clock signal GCLK2 from the first gated clock signal GCLK1 is not analogous to one of the intervening inverters described in relation to FIG. 1A. Rather, the inverter 117 is internal to the clock gater 110B and generates one clock signal (i.e., the second gated clock signal GCLK2) among the one or more clock signals provided by the clock gater 110B. Thus, the term “gated clock signal” as used hereafter may refer, singularly or collectively, to one or more gated clock signals provided by a clock gater.

The first clock sink 120A includes a first master latch 121 and a first slave latch 123, and the second clock sink 120B includes a second master latch 122 and a second slave latch 124. The first gated clock signal GCLK1 is directly connected to a clock terminal of each of the master latches 121 and 122, and the second gated clock signal GCLK2 is directly connected to a clock terminal of each of the slave latches 123 and 124 without intervening inverters.

In the illustrated example of FIG. 2, the clock gater 110B includes a mask circuit 111 as well as the inverter 117. The mask circuit 111 control enabling/disabling of the received clock signal CLK in response to (e.g.,) a logic level (high/low) of the enable signal EN. The inverter 117 is connected between the first output ‘A’ and the second output ‘B’ of the clock gater 110A to respectively provide the first gated clock signal GCLK1 and the second gated clock signal GCLK2.

Thus, an output of the mask circuit 111 may be used as the first output ‘A’ to directly provide the first gated clock signal GCLK1 to the clock inputs of the respective master latches 121 and 122, whereas an output of the inverter 117 may be used as the second output ‘B’ to directly provide the second gated clock signal GCLK2 to the clock inputs of the respective slave latches 123 and 124.

In the illustrated example of FIG. 2, the mask circuit 111 includes a latch 113 and a NAND gate 115. The latch 113 may be used to latch data indicated by the logic level of the enable signal EN in response to a falling edge of a clock signal CLK. The NAND gate 115 may perform a NAND operation on the clock signal CLK and an output of the latch 113 to generate the first gated clock signal GCLK1. However, this is just one possible example of a mask circuit that might be used in a clock gater consistent with embodiments of the inventive concept.

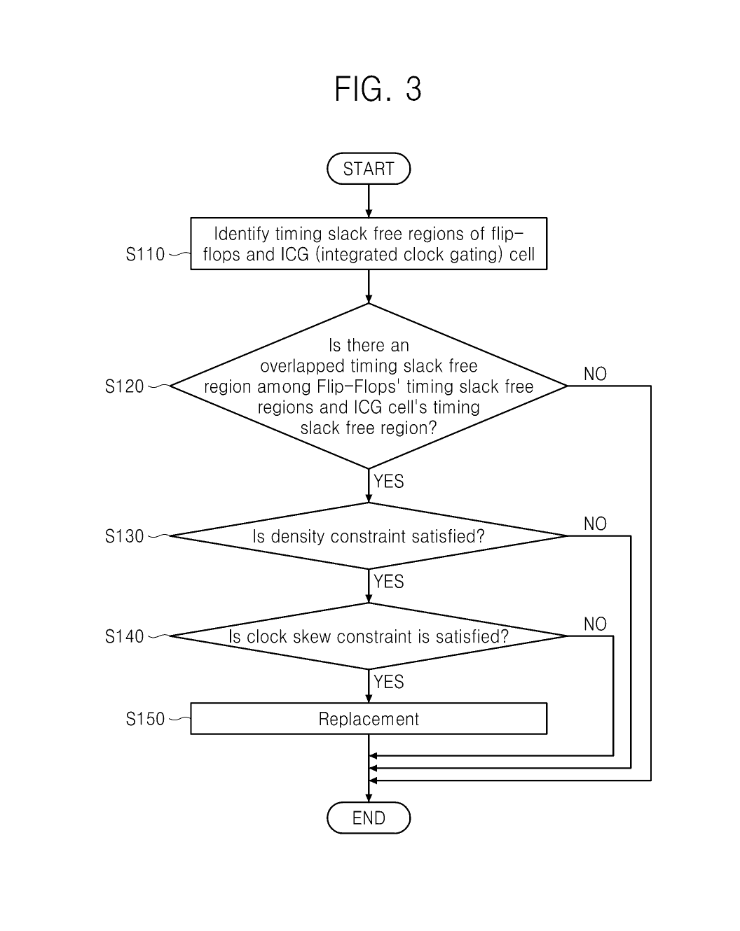

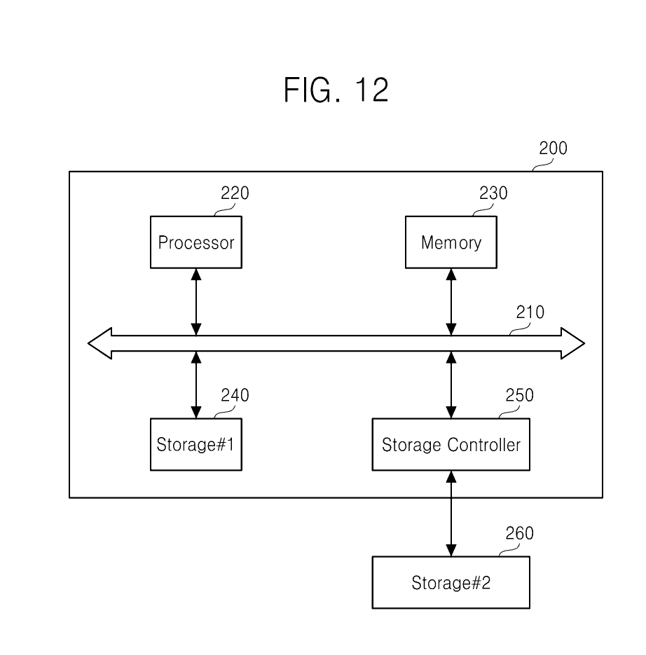

FIG. 3 is a flowchart summarizing one method of designing an integrated circuit including a standard cell according to embodiments of the inventive concept. Referring to FIG. 3, the design method may be embodied as a computer-readable software or software component(s) (hereafter, “software”) that when executed enable the improved design optimization of a standard cell including a clock network. Those skilled in the art will recognize that execution of the software enabling design methods consistent with embodiments of the inventive concept may be variously performed. For example, the software may be executed by a processor, such as the one (processor 220) described in relation to FIG. 12 hereafter.

It is assumed for purposes of this description that the clock sinks of the clock network at issue are flip flops. However, this is just an example of possible clock sinks that may be incorporated into standard cells consistent with embodiments of the inventive concept.

In the method of FIG. 3, timing slack free regions associated with the flip-flops are identified in relation to a corresponding ICG cell (S110). “Timing slack” or “slack” is a difference between actual or achieved time and a desired time for a particular timing path under defined conditions. For example, timing slack for a flip-flop may include input slack and/or output slack. Input slack is a maximum allowable wire delay without timing violations between the flip-flop and (e.g.,) a fan-in gate associated with the flip-flop. Output slack is a maximum allowable wire delay without timing violations between the flip-flop and (e.g.,) a fan-out gate associated with the flip-flop.

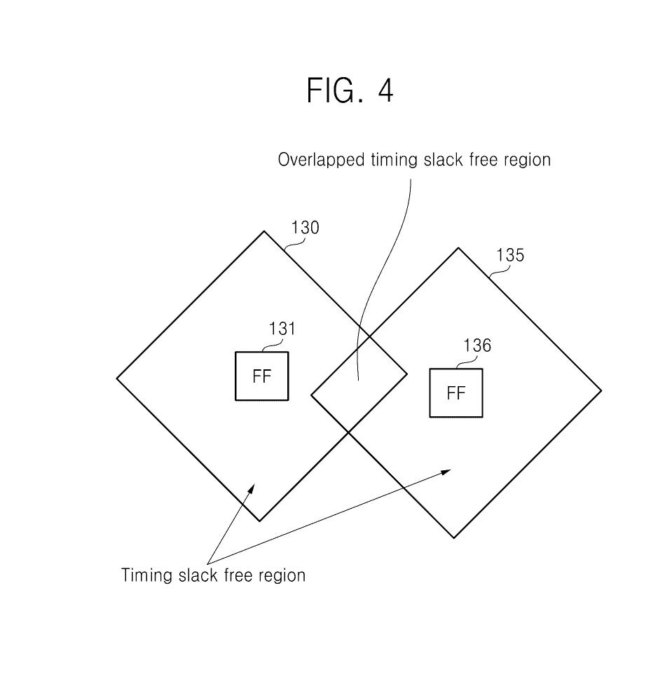

After identification of timing slack, as further illustrated in FIG. 4, respective timing slack free regions (e.g.,) 130 and 135 associated with first and second flip-flops 131 and 136 may be further identified. Each of the first and second flip-flops 131 and 136 may be placed or located anywhere in its respective timing slack free region 130 and 135. Accordingly, certain timing constraint associated with the interconnection (e.g., pins, such as pin(s) of the fan-in and/or fan-out gates) of the first and second flip-flops 131 and 136 in their respective timing slack free regions 130 and 135 may be satisfied. Further an “overlapped timing slack free region” between the first and second timing slack free regions 130 and 135 may be identified.

Once the timing slack free regions for clock sinks have been identified (S110) and overlapped timing slack free region(s) have been further identified (S120), certain constraint (e.g., density constraint and clock skew constraint) checks will be performed by methods like the one illustrated in FIG. 3. However, examples of these constraints checks will be described hereafter with reference to FIGS. 3-6.

The standard cells (e.g., 100B or 100C shown in FIG. 1B or 2) generated by the design methods of the inventive concept tend to decrease wiring overhead for clock path(s) in clock networks (e.g., a clock tree or clock mesh), and therefore reduce clock power. However, in order to replace conventional clock networks (e.g., 100A shown in FIG. 1A) with improved clock networks consistent with the inventive concept, it is necessary to check and determine satisfaction of the resulting improved clock networks with various constraints. As will be appreciated by those skilled in the art, there are many different constraints that may exist with respect to a standard cell, and its corresponding integrated circuit. Such constraints may include timing constraint(s), density constraint(s), such as those that are associated with a bin, and clock skew constraint(s).

Thus, using the first steps of the method described in relation to FIG. 3, clock sinks may be placed in a corresponding timing slack free region, such that certain timing constraint(s) associated with pins (e.g., pins related to a fan-in and/or fan-out gate) connected to each of the clock sinks are satisfied. Additionally, specialized software may be used to determine whether or not certain density constraint(s) are satisfied, once the timing constraint(s) have been satisfied. For example, a density constraint associated with a particular bin may be a placement density constraint.

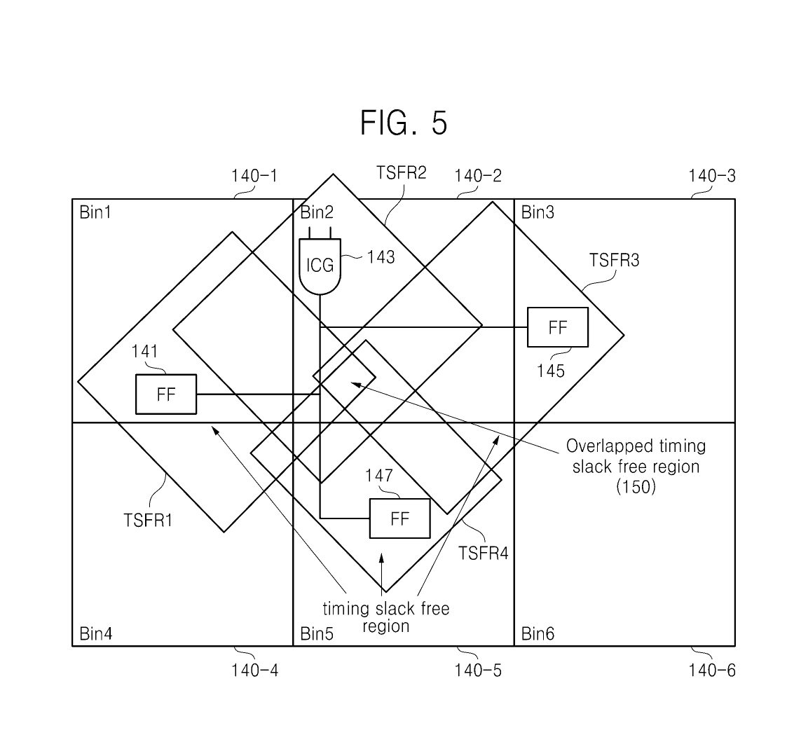

As previously reference, FIG. 4 conceptually illustrates first and second timing slack free regions, as well as an overlapped timing slack free region between the first and second timing slack free regions. FIG. 5 is a somewhat more complicated conceptual diagram further illustrating the role certain timing constraint(s) play in the generation of a standard cell according to embodiments of the inventive concept.

Referring to FIGS. 3 and 5, a first flip-flop 141 may be placed in a first timing slack free region TSFR1 defined in bins 140-1, 140-2, 140-4, and 140-5, a clock gater 143 may be placed in a second timing slack free region TSFR2 defined in the bins 140-1, 140-2, 140-4, and 140-5, a second flip-flop 145 may be placed in a third timing slack free region TSFR3 defined in bins 140-2, 140-3, 140-5, and 140-6, and a third flip-flop 147 may be placed in a fourth timing slack free region TSFR4 defined in the bins 140-1, 140-2, 140-4, and 140-5. Here again, flop flops (FF) are used as one example of various clock sinks that may be included in standard cells according to embodiments of the inventive concept. For example, each of the flip-flops 141, 145, and 147 indicated in FIG. 5 may in certain embodiments be a register including multiple flip-flops.

As previously described, software (e.g., a specialized software tool) is used to check each timing slack free regions TSFR1, TSFR3, and TSFR4 for the flip-flops 141, 145, and 147, and a timing slack free region TSFR2 of the clock gater 143 (S110). Then, the software may be used to determine whether or not an overlapped timing slack free region 150 exists between the timing slack free regions TSFR1, TSFR3, and TSFR4 for each of the flip-flops 141, 145, and 147 and the timing slack free region TSFR2 for the clock gater 143 (S120).

Assuming that an overlapped timing slack free region 150 exists (S120=YES), a merged standard cell may be placed in the overlapped timing slack free region 150, provided the software determines that one or more density constraint(s) associated with at least one of bins 1 through 6 is satisfied (S130).

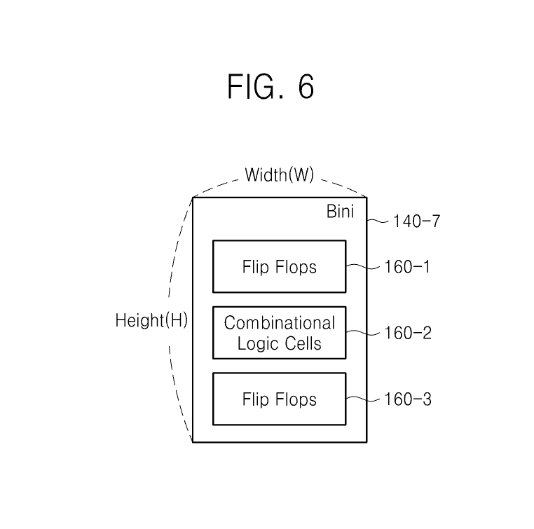

FIG. 6 is still another conceptual diagram further illustrating the foregoing density constraint determination for a bin that may be used using the generation of a standard cell according to embodiments of the inventive concept. Referring to FIGS. 3, 5 and 6, the software may be used to determine whether a density constraint associated with Bin2 140-2 and related to the overlapped timing slack free region 150 is less than or equal to a maximum placement density value(s). For example, a maximum placement density value for Bin2 140-2 may be determined on the basis of one or more placement area(s) for the flip-flops 141, 145, 147 as well as the clock gater 143. Certain placement density area(s) may be expressed in terms of height and/or width, a number of constituent elements in the bin, etc.

In this regard, there are a number of different approaches that may be used to determine a density, such as the density associated with one or more bins. Some densities (and corresponding density constraints) may be expressed as a specific value, other as a range or percentage of values, etc. Some density determination approaches may be computationally based. For example, assuming the example illustrated in FIGS. 5 and 6, including Bin2 140-2 and the overlapped timing slack free region 150, Equation 1 below may be used to calculate a corresponding bin density (DOB).

$$D O B = \frac{{A}_{F} + {A}_{C}}{W H} \qquad ( Equation 1 )$$

In Equation 1 and referring to FIG. 6, the term ‘A_{F}’ denotes a first placement area for flip-flops 160-1 disposed on one side of combinational logic cells 160-2 disposed in a second placement area denoted by the term ‘A_{C}’. Given a prescribed width (W) and height (H) for the bin, a density for the bin may be determined. The calculated bin density (DOB) may then be compared with a given density constraint (D_{MAX}). So long as bin density (DOB) remains not greater than the density constraint (D_{MAX}), the density constraint is deemed to be satisfied (S130=YES).

In this manner, for example, an appropriate number of clock sinks (e.g., flip-flops, registers and/or combinational logic cells) for a particular bin may be determined. For example, the same determination approach may be used in relation to a second placement area 160-3 and the combinational logic cells 160-2 in FIG. 6. In this regard, one or more density constraints (i.e., maximum placement density value(s) may be externally provided.

Once the software has determined that one or more density constraints (e.g., maximum placement density) has been satisfied, it may further be used to determine whether or not the standard cell satisfies one or more clock skew constraints (S140). Alternatively, the DOB may be calculated as a ratio of area occupied by all of elements included in the bin to area of the bin or by dividing the area of the bin by a number of all of elements included in the bin.

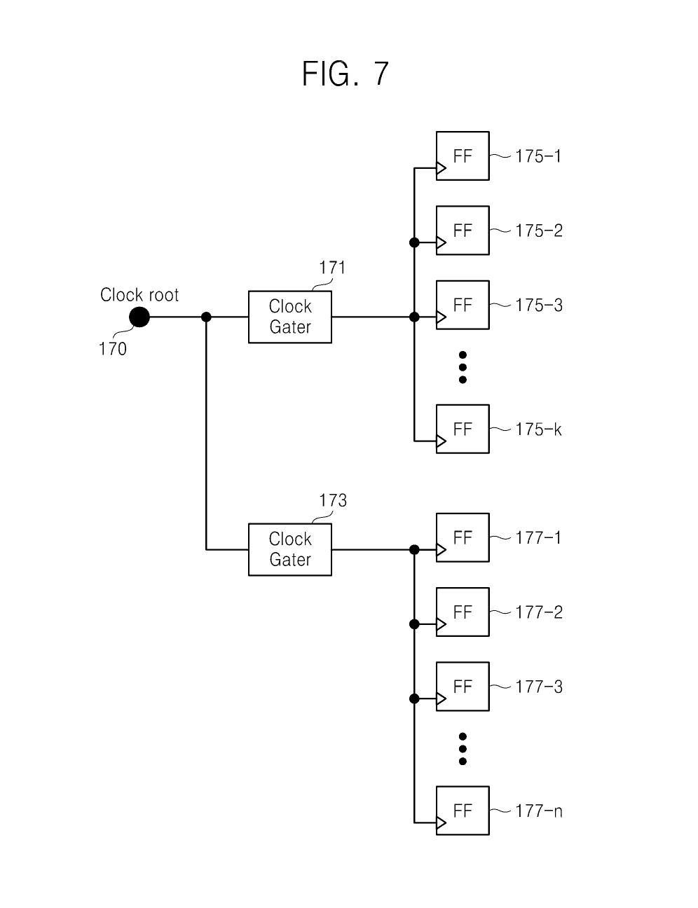

FIG. 7 is a circuit diagram illustrating the determination of a clock skew constraint for a standard cell being generated according to embodiments of the inventive concept. Referring to FIGS. 3 and 7, software may be used to determine a clock skew constraint to preclude any clock skew problems associated with the standard cell including at least one clock gater and multiple clock sinks (S140). For example, a clock skew constraint may be determined using Equation 2 below.

|D_{S}−Dₗ|≦Sₘₐₓ (Equation 2)

Here, a first distance ‘Ds’ may be calculated for one of the multiple clock sinks 175-1 through 175-k, and 177-1 through 177-n in relation to a clock root 170, and a second distance Dl may then be calculated between for another one of the clock sinks 175-1 through 175-k, and 177-1 through 177-n in relation to the clock root 170. Then, a difference (e.g., an absolute value of the difference) may be calculated between the first distance DS and second distance Dl. The calculated difference may then be compared with a given maximum allowable skew distance, Smax.

For example, assuming a first clock sink (e.g., 175-3) closest to the clock root 170 among the clock sinks, and a second clock sink (e.g., 177-n) farthest from the clock root 170, a corresponding difference may be calculated and compared with a maximum allowable skew distance, Smax. This calculation/comparison will be made once the various elements (clock sinks and clock gaters) have been placed and merged into the standard cell.

Where a determination is made that a standard cell being generated according to an embodiment of the inventive concept, violates (i.e., fails to satisfy) a density constraint or a clock skew constraint, one or more of the constituent elements (e.g., clock sinks and/or clock gaters) of a clock network may be replaced and/or repositioned in the standard cell to correct the violation (S150). In other words, violation of a constraint will preclude placement of constituent elements in an overlapped timing slack free region 150.

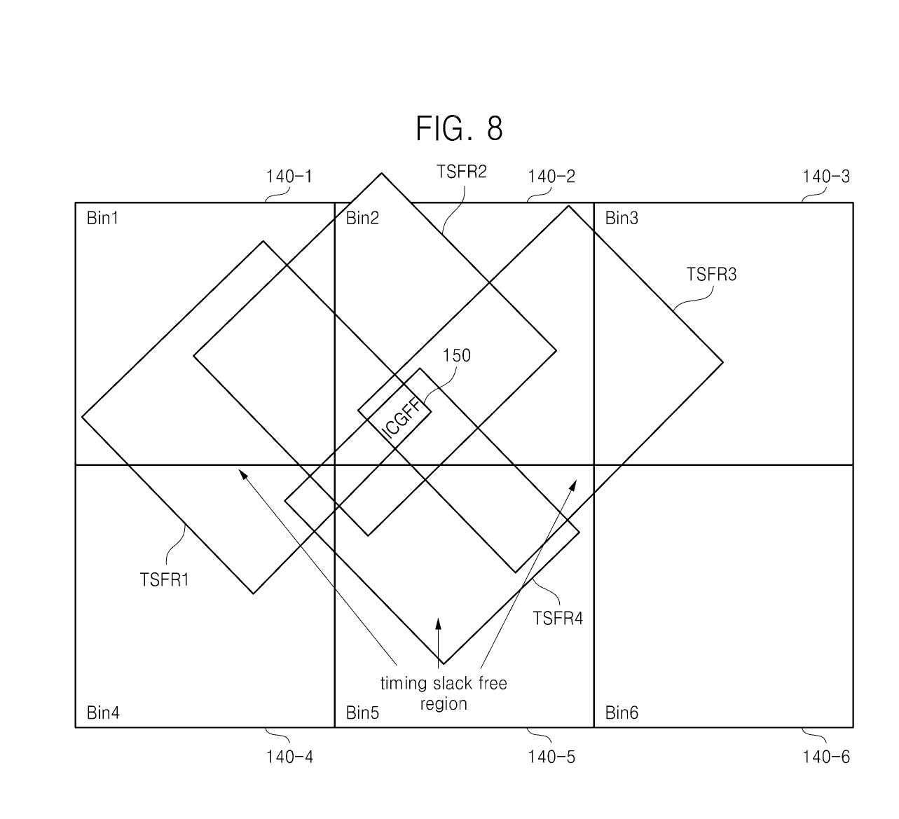

FIG. 8 is another conceptual diagram that extends the example of FIG. 5. Here, a standard cell including a ICGFF is placed in an overlapped timing slack free region 150 using the method of FIG. 3, where at least one of timing constraint, density constraint, and clock skew constraint is satisfied.

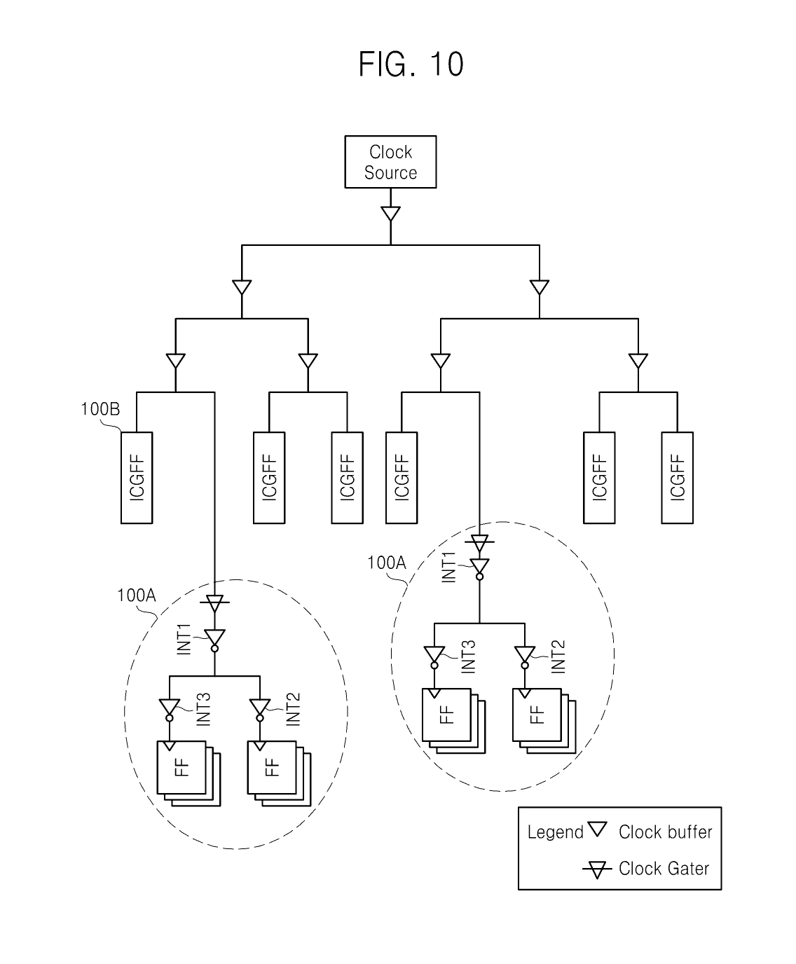

FIG. 10 is a circuit diagram (a clock tree) illustrating a clock path that may be defined, at least in part, by a standard cell according to embodiments of the inventive concept. The clock path includes a plurality of clock buffers, a plurality of ICGFF circuits 100B like the ones previously described in relation to FIGS. 1B, 2, 5, and 7, as well as at least one conventional clock network 100A like the one shown in FIG. 1A.

Once all relevant timing constraint(s), density constraint(s), and clock skew constraint(s) are satisfied, a standard cell will include at least one clock network 100B (e.g., a ICGFF) placed in an overlapped timing slack free region. However, if one or more of the timing, density and clock skew constraint(s) cannot be satisfied, a conventional clock network 100A may be used.

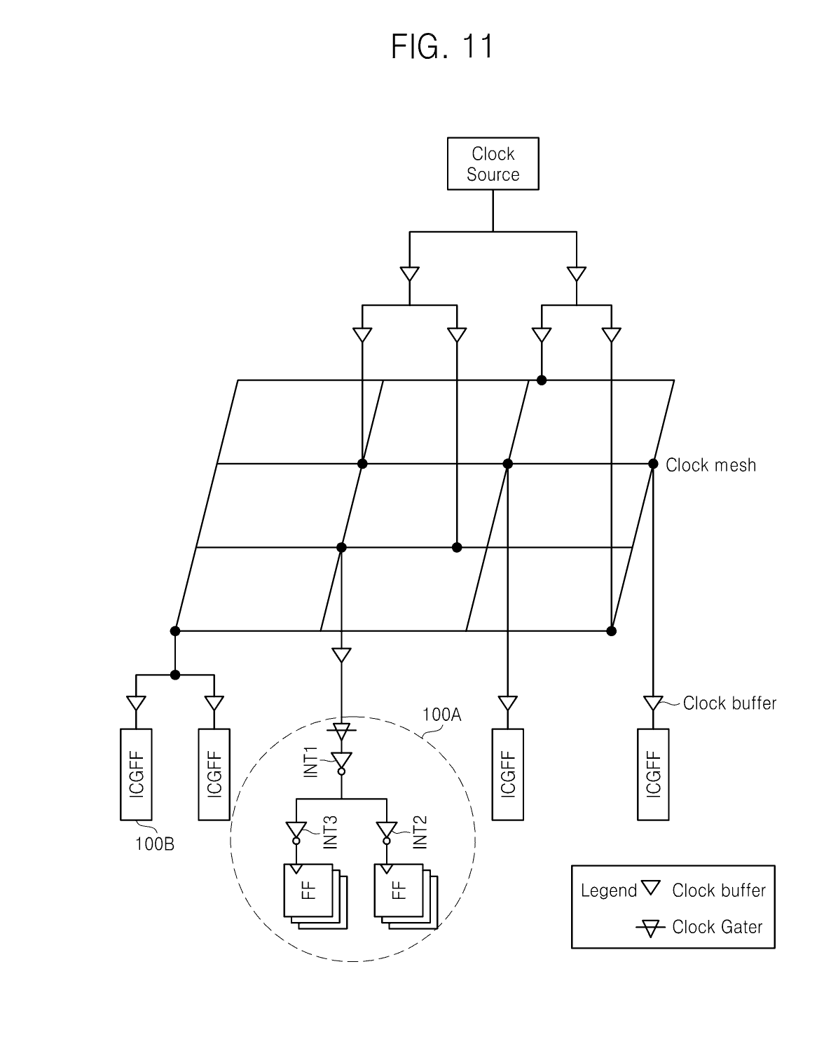

FIG. 11 is another circuit diagram (a clock mesh illustrating a clock path that may be defined, at least in part, by a standard cell according to embodiments of the inventive concept. Here again, the clock path includes a plurality of clock buffers, a plurality of ICGFF circuits 100B like the ones previously described in relation to FIGS. 1B, 2, 5, and 7, as well as at least one conventional clock network 100A like the one shown in FIG. 1A. If relevant timing, density, and clock skew constraint(s) are satisfied, a standard cell will include at least one clock network 100B (e.g., a ICGFF) placed in an overlapped timing slack free region. However, if one or more of the timing, density and clock skew constraint(s) cannot be satisfied, a conventional clock network 100A may be used.

FIG. 12 shows a block diagram of a computing system 300 that may be used to design one or more standard cells for semiconductor devices and/or integrated circuits according to embodiments of the inventive concept. The computing system 300 generally includes a controller 200 and a second storage device 260.

The controller 200 includes a bus 210, a processor 220, a memory 230, a first storage device 240, and a second storage device controller 250. The processor 220, memory 230, first storage device 240, and second storage device controller 250 communicate data and/or instruction via the bus 210.

The processor 220 may be used to execute software stored in the first storage device 240 or second storage device 260. The software may perform operations necessary for designing an integrated circuit which includes the at least one standard cell, like the ones described above in relation to FIGS. 1A, 2, 5, 7, 10 and 11.

The first storage device 240 may be embodied as a hard disk drive (HDD) or solid state drive or solid state disk (SSD). The second storage device 260 may be a removable storage device. The second storage device 260 may be an optical storage medium, a magnetic storage medium, or an electronic storage medium. However, the foregoing are just possible examples.

According to embodiments of the inventive concept, software (e.g., data, instructions, code, commands, and related components) may be loaded onto the memory 230 from the first storage device 240 or the second storage device 260. The memory 230 may be a random access memory (RAM), a dynamic RAM (DRAM) or a static RAM (SRAM). The software loaded onto the memory 230 may be executed by the processor 220. For example, the software may be loaded onto a cache of the processor 220 from the first storage device 240 or the second storage device 260.

The second storage device controller 250 may control communication of data between the controller 200 and second storage device 260 under the control of the processor 220. For example, the second storage device controller 250 may write data in the second storage device 260 or read data from the second storage device 260.

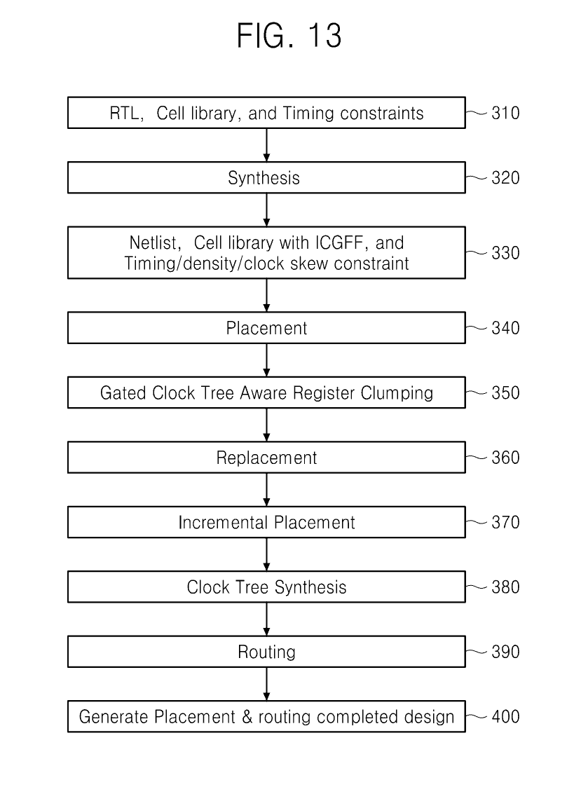

FIG. 13 is a flowchart summarizing a method of designing an integrated circuit which includes a standard cell according to at least one embodiment of the inventive concept using the computing system shown in FIG. 12.

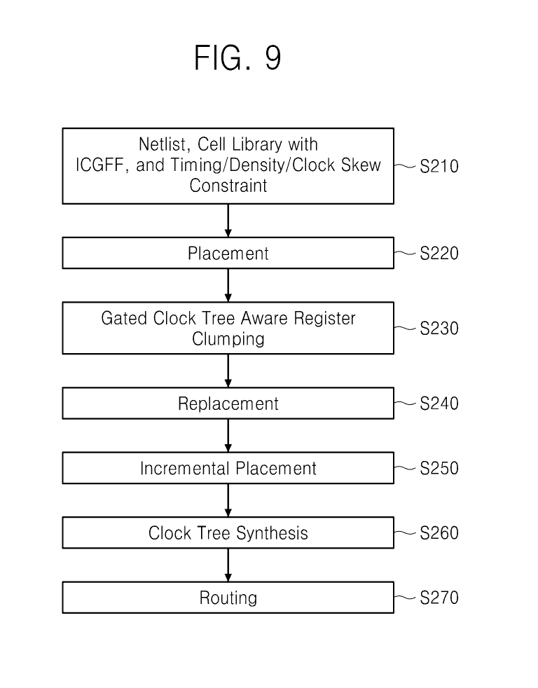

Referring to FIGS. 9, 10, 11 and 12, software stored in the first storage device 240 or the second storage device 260 may be loaded to the memory 230 or a cache of the processor 220. Software may include a netlist for designing an integrated circuit, a cell library including at least one standard cell, as well as timing, density, and/or clock skew constraint(s). For example, the netlist may be generated based on a register-transfer level (RTL).

The cell library may include, for example, standard cells for AND, OR, XOR and XNOR gates, inverters, clock sinks, flip-flops, registers, latches, and buffers in addition to various merged standard cells according to embodiments of the inventive concept. The software may include an ASIC placement and routing tool. For example, the ASIC placement and routing tool may place (or design) an integrated circuit (e.g., a standard cell) using a netlist, a cell library including a merged standard cell (e.g., ICGFF), a timing constraint, a density constraint, and a clock skew constraint (S210).

The electronic circuit 100A shown in FIG. 1A may be placed by the ASIC placement and routing tool (S220). The ASIC placement and routing tool may place the electronic circuit 100A using a netlist and a cell library (S220).

The ASIC placement and routing tool may move clock sinks FF included in the electronic circuit 100A closer to the clock gater 110A. For example, the ASIC placement and routing tool may move the clock sinks FF included in the electronic circuit 100A closer to the clock gater 110A using gated clock tree aware register clumping (S230). The gated clock tree aware register clumping may be an operation of pulling the clock sinks FF included in the electronic circuit 100A closer to the clock gater 110A.

The ASIC placement and routing tool may determine replacement conditions. That is, the replacement conditions may be at least one of a timing constraint, a density constraint, and a clock skew constraint. When the at least one of the timing constraint, the density constraint, and the clock skew constraint is satisfied, the ASIC placement and routing tool may place the electronic circuit 100B shown in FIG. 1B instead of the electronic circuit 100A shown in FIG. 1A in the overlapped timing slack free region 150 (S240). That is, the ASIC placement and routing tool may perform a circuit design using a merged standard cell.

The ASIC placement and routing tool may place a merged standard cell in the overlapped timing slack free region 150, and then perform incremental placement of the merged standard cell (S250). The incremental placement may be an operation of finely tuning a size of a merged standard cell placed in the timing slack free region 150.

The ASIC placement and routing tool may place an electronic circuit which includes a clock path shown in FIGS. 10 and 11. The ASIC placement and routing tool may synthesize the clock path (for example, a clock tree or a clock mesh) shown in FIGS. 10 and 11 (S260), and may rout corresponding wirings in an electronic circuit included in the clock path (S270).

An electronic circuit generated by the ASIC placement and routing tool is mass-produced by a semiconductor wafer manufacturing facility, and a function and a performance of an electronic circuit embodied in a semiconductor wafer are tested. After a test for an electronic circuit embodied in a semiconductor wafer is ended, the electronic circuit may be included as a part of an electronic device. The electronic device may be a PC, a system on chip (SoC), a processor, a CPU, an application processor, a GPU, a digital signal processor, or a mobile device; however, it is not limited thereto.

Referring to FIGS. 12 and 13, data and/or instructions (or software components) stored in the first storage device 240 or the second storage device 260 may be loaded to the memory 230 or a cache of the processor 220. The data and/or instructions (or software components) may include a register-transfer level (RTL) for designing an integrated circuit, a cell library including a merged standard cell, and a timing constraint(s) (310). The timing constraint(s) may be a constraint(s) necessary for generating a netlist; however, it is not limited thereto.

The data and/or instructions (or software components) may include the ASIC placement and routing tool.

The ASIC placement and routing tool may synthesize a RTL, a cell library including a merged standard cell, and a timing constraint(s) (320), and generate a netlist corresponding to a result of the synthesis. The ASIC placement and routing tool may place an integrated circuit using the netlist, the cell library including the merged standard cell, the timing constraint, a density constraint, and a clock skew constraint (330 and 340).

The electronic circuit 100A shown in FIG. 1A may be placed by the ASIC placement and routing tool (340). The ASIC placement and routing tool may place the electronic circuit 100A using a netlist and a cell library (340). The ASIC placement and routing tool may move clock sinks FF included in the electronic circuit 100A closer to the clock gater 110A using gated clock tree aware register clumping (350).

When at least one of the timing constraint, the density constraint, and the clock skew constraint is satisfied, the ASIC placement and routing tool may place the electronic circuit 100B shown in FIG. 1B instead of the electronic circuit 100A shown in FIG. 1A in the overlapped timing slack free region 150 (360). The ASIC placement and routing tool may place a merged standard cell in the overlapped timing slack free region 150 and then perform an incremental placement of the merged standard cell (370).

The ASIC placement and routing tool may place an electronic circuit which includes the clock path shown in FIGS. 10 and 11. The ASIC placement and routing tool may synthesize the clock path (for example, a clock tree or a clock mesh) shown in FIGS. 10 and 11 (380), and rout corresponding wirings in an electronic circuit including the clock path (390). The ASIC placement and routing tool may generate (or output) a design in which placement and routing are completed, through steps 310 to 390 (400).

As inverters, i.e., clock inverters, between a clock gater and clock sinks are removed, an integrated circuit designed according to a method of exemplary embodiments of the inventive concept can reduce a clock power consumed by the inverters.

As the clock inverters are removed, and the clock gater and the clock sinks are merged, a clock wire length is decreased, and thereby a clock power is reduced. Moreover, since clock inverters are removed from the integrated circuit, a clock latency caused by the inverters is reduced. The integrated circuit designed according to a method of exemplary embodiments of the inventive concept can reduce a layout area (or size).

Although a few embodiments of the general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of generating a design for an integrated circuit, the method comprising:
replacing a first clock network with a second clock network in the design, wherein the second clock network is defined by a standard cell stored in a storage device,
the first clock network includes a first clock gater connected to first clock sinks via intervening inverters, and
the second clock network includes a second clock gater directly connected to second clock sinks without intervening inverters.

2. The method of claim 1, wherein the first clock sinks include a first clock sink and a second clock sink, and the method further comprises:
identifying a first timing slack free region associated with the first clock sink, identifying a second timing slack free region associated with the second clock sink, and identifying a third timing slack free region associated with the first clock gater; and
generating the standard cell only upon determining that an overlapped timing slack free region exists between the first timing slack free region, the second timing slack free region, and the third timing slack free region.

3. The method of claim 2, wherein the generation of the standard cell comprises:
placing the first clock gater in the overlapped timing slack free region as the second clock gater;
placing the first clock sink in the overlapped timing slack free region as a second clock sink; and
placing the second clock sink in the overlapped timing slack free region as a second clock sink.

4. The method of claim 3, wherein the placing of the first clock gater, the first clock sink and the second clock sink are performed in relation to a bin including the overlapped timing slack free region.

5. The method of claim 4, wherein the generation of the standard cell further comprises determining whether a density constraint is satisfied.

6. The method of claim 5, wherein the density constraint is defined in relation to the bin and is a maximum placement density constraint.

7. The method of claim 6, wherein the determining of whether the maximum placement density constraint is satisfied by the standard cell comprises:
calculating a density of the bin (DOB) after the placing of the first clock gater, the first clock sink and the second clock sink in the overlapped timing slack free region; and
comparing the DOB to the maximum placement density constraint.

8. The method of claim 7, wherein the DOB is calculated in relation to a first placement area for the first and second clock sinks in the bin (A_{F}), a second placement area for combinational logic cells in the bin (A_{C}), a width of the bin, and a height of the bin according to the equation
$$D O B = \frac{{A}_{F} + {A}_{C}}{W H} .$$

9. The method of claim 4, wherein the generation of the standard cell method further comprises determining whether a clock skew constraint is satisfied after determining that the density constraint is satisfied.

10. The method of claim 9, wherein the determining of whether the clock skew constraint is satisfied comprises:
calculating a first distance between one of the first clock sinks and a clock root;
calculating a second distance between another one of the first clock sinks and the clock root;
calculating a difference between the first distance and the second distance; and
comparing the calculated difference to a maximum allowable clock skew distance.

11. The method of claim 10, wherein the one of the first clock sinks is a clock sink closest to the clock root among the first clock sinks, and the another one of the first clock sinks is farthest from the clock root among the first clock sinks.

12. The method of claim 1, wherein the second clock gater provides a first gated clock signal and an inverted version of the first gated clock signal as a second gated clock signal,
each of the second clock sinks includes a master latch and a slave latch, and
an output of the second clock gater is directly connected to a clock terminal of the slave latch included in each of the second clock sinks.

13. The method of claim 12, wherein the second clock gater comprises:
a mask circuit that masks a received clock signal in response to an enable signal; and
an inverter that receives the first gated clock signal from the mask circuit and generates the second gated clock signal.

14. The method of claim 1, wherein the second clock network is a clock tree or a clock mesh.

15. A method of designing an integrated circuit comprising:
referencing a netlist related to the integrated circuit design, a cell library related to the netlist, and constraints related to the netlist, generating a first clock network connecting a first clock gater to first clock sinks via intervening inverters, wherein the netlist, cell library and constraints are stored in at least one storage device;
determining whether the first clock network satisfies the constraints after changing a placement position of at least one of the first clock sinks;
generating a standard cell that defines a second clock network replacing the first clock network, wherein the second clock network comprises a second clock gater directly connected to second clock sinks without intervening inverters.

16. The method of claim 15, further comprising:
identifying a timing slack free regions associated with the first clock sinks;
identifying a timing slack free region associated with the first clock gater;
identifying an overlapped timing slack free region between the timing slack free region associated with the first clock sinks, and the timing slack free region associated with the first clock gater;
placing the first clock gater and first clock sinks in the overlapped timing slack free region in relation to a bin including the overlapped timing slack free region.

17. The method of claim 16, further comprising:
after placing the first clock gater and first clock sinks in the overlapped timing slack free region, determining whether a density constraint is satisfied; and thereafter
determining whether a clock skew constraint is satisfied.

18. A method of designing a standard cell defining a clock network including a clock gater and clock sinks, the method comprising:
identifying an overlapped timing slack region between the clock gater and clock sinks;
placing the clock gater and clock sinks in the overlapped timing slack region;
after placement of the clock gater and clock sinks in the overlapped timing slack region, determining whether the standard cell satisfies at least one of a density constraint and a clock skew constraint,
wherein the clock gater is directly connected to the clock sinks without intervening inverters.

19. The method of claim 18, wherein each one of the clock sinks is one of a flip-flop, a register, a latch, a sequential logic circuit, and a sequential logic cell.

20. The method of claim 18, wherein the placing of the clock gater and clock sinks in the overlapped timing slack free region are performed in relation to a bin including the overlapped timing slack free region, and
the density constraint is related to the bin.
